(19) United States
(12) Patent Application Publication
(10) Pub. No.: US 2016/0179881 A1
(43) Pub. Date: Jun. 23, 2016

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: Takuya Kubo, Kawasaki-shi (JP)

(21) Appl. No.: 15/054,581

(22) Filed: Feb. 26, 2016

Related U.S. Application Data
(63) Continuation of application No. 13/456,851, filed on Apr. 26, 2012.

(30) Foreign Application Priority Data
May 13, 2011 (JP) 2011-108732

(51) Int. Cl. G06F 17/30

(52) U.S. Cl. CPC G06F 17/30424; G06F 17/30554; G06F 17/3028; G06F 17/30247

(57) ABSTRACT

An information processing apparatus for performing a content search performs search for contents that match a predetermined search condition, generates list data of identification information corresponding to the found contents, wherein identification information corresponding to contents that were newly found while the search is being performed is added to the list data that has been generated so far, in accordance with a sorting condition, repeatedly sorts a sequence of the identification information included in the list data in accordance with a predetermined timing. The identification information corresponding to contents that were newly found is added to the list data without conforming to the sorting condition, from when the sorting was performed by the sorting unit until when the sorting is performed next.

### BACKGROUND OF THE INVENTION

1. Field of the Invention

The present invention relates to an information processing apparatus, an information processing method, and a non-transitory computer readable storage medium.

2. Description of the Related Art

When searching for searchable content such as an image, there is technology in which search results are displayed according to a predetermined sorting order. When displaying the content of the search results in a sorted manner, it is generally conceivable to use a method of performing sorting each time a content that matches a condition is found. According to Japanese Patent Laid-Open No. 2007-102549, facial region extraction is performed for each image, feature amounts are calculated for the facial regions, and the images are displayed sorted alongside facial images for which feature amount calculation has already ended.

### SUMMARY OF THE INVENTION

In the case where a desired content is found while searching is being performed, there are cases where there is a desire to immediately select that content and execute the next operation. However, when an attempt is made to select the content while searching is being performed, in a case where sorting is performed each time a content that matches a condition is found, it is possible that the content that is to be selected will move to a different position, and that the wrong content will be selected. In particular, in the case of using this technology when searching for content over a network or performing a search using feature amounts calculated for facial images, each search is time-consuming, and it is possible that images will be frequently sorted while the search is being performed.

One of embodiments of the present invention relates to an information processing apparatus for performing a content search comprising, a searching unit configured to perform search for contents that match a predetermined search condition, a generating unit configured to generate list data of identification information corresponding to contents found by the searching unit, wherein the generating unit adds identification information corresponding to contents that were newly found while the search is being performed by the searching unit to the list data that has been generated so far, and a sorting unit configured to, in accordance with a sorting condition, repeatedly sort a sequence of the identification information included in the list data in accordance with a predetermined timing, wherein from when the sorting was performed by the sorting unit until when the sorting is performed next, the generating unit adds identification information corresponding to contents that were newly found by the searching unit to the list data without conforming to the sorting condition.

Another one of embodiments of the present invention relates to an information processing method for performing a content search comprising, a searching step of performing a search for contents that match a predetermined search condition, a generating step of generating list data of identification information corresponding to contents found in the searching step, wherein in the generating step, identification information corresponding to contents that were newly found while the search is being performed in the searching step is added to the list data that has been generated so far, and a sorting step of repeatedly sorting a sequence of the identification information included in the list data in accordance with a predetermined timing, wherein from when the sorting was performed in the sorting step until when the sorting is performed next, in the generating step, identification information corresponding to contents that were newly found in the searching step is added to the list data without conforming to the sorting condition.

Further features of the present invention will be apparent from the following description of exemplary embodiments with reference to the attached drawings.

### BRIEF DESCRIPTION OF THE DRAWINGS

FIG. 1 is a block diagram showing an example of the configuration of an information processing apparatus according to an embodiment of the present invention.

FIG. 2 is a flowchart showing an example of content search processing according to the embodiment of the present invention.

FIG. 3 is a diagram showing an example of a display of a main screen of an image management application according to the embodiment of the present invention.

FIG. 4 is a diagram showing an example of a setting screen in the case of executing a facial search in the image management application according to the embodiment of the present invention.

FIGS. 5A to 5C are diagrams for describing search results before and after sorting in the case of executing a facial search in the image management application according to the embodiment of the present invention.

FIGS. 6A and 6B are diagrams for describing an example of a display in the case where a content among the search results is selected while a facial search is being executed in the image management application according to the embodiment of the present invention.

FIG. 7 is a flowchart showing an example of processing for temporarily stopping the sorting of search results in content search processing according to the embodiment of the present invention.

FIG. 8 is a flowchart showing an example of processing for performing sorting when a predetermined time has elapsed since a user operation ceased to be performed in a content search according to the embodiment of the present invention.

### DESCRIPTION OF THE EMBODIMENTS

The following describes an embodiment of the present invention. The present embodiment will be described taking the example of the case where a facial search is performed by an image management application. However, the range of application of the present invention is not intended to be limited to only a facial search related to images. There is no limitation to images, and the present invention can be applied to other content such as document data, moving image data, and audio data. Also, there are no particular limitations on the data format. Furthermore, similarity determination is not limited to a determination method using a facial image as the search key, and it is possible to perform similarity determination in which the search key that is used is a character, an image, audio, or anything else that can be used as a search key.

In the present invention, the fact that the degree of similarity or degree of association with information serving as the search key is greater than or equal to certain value is used as a content search condition. Accordingly, the present invention can be applied to any content on which a determination regarding this search condition can be made. It should be noted that the example of an image management application based on a facial image search is described below in order to simplify the description.

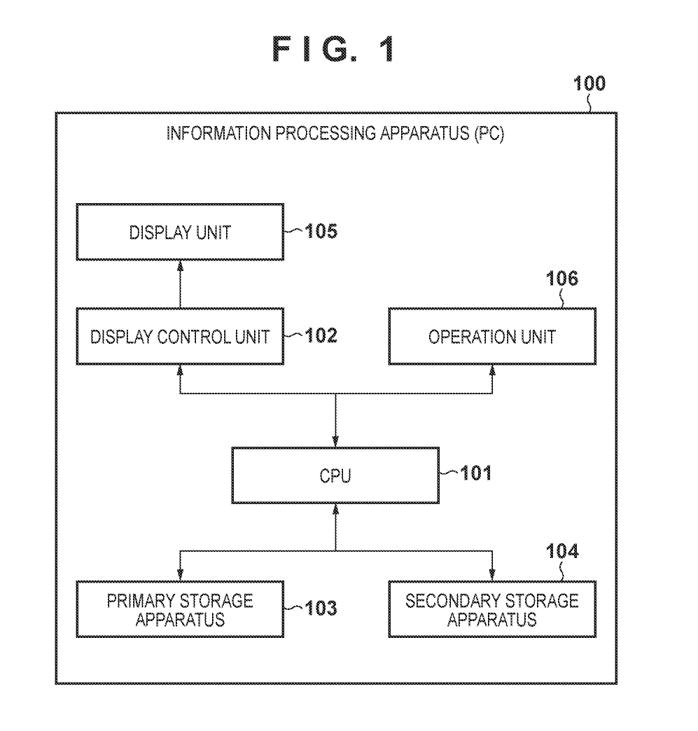

FIG. 1 is a diagram showing the system configuration of the present embodiment. An image management application corresponding to the present embodiment is installed in an information processing apparatus 100. This information processing apparatus is realized as a personal computer (PC), for example. However, there is no limitation to a PC, and the information processing apparatus may be any other information processing apparatus that can search for content based on a search key, such as a mobile phone, a digital camera, a digital video camera, a smartphone, a media player, or a gaming terminal.

A CPU 101 is a processing unit that controls operations performed by the information processing apparatus 100. Note that in the present embodiment, the CPU 101 can function as a search processing unit for searching for content, or a sorting processing unit for sorting search results. A display control unit 102 is a display controller for causing a display unit 105 to display the results of content search processing that corresponds to the present embodiment. A primary storage apparatus 103 is configured by a RAM or the like, stores a program executed by the CPU 101 and data used in processing, and functions as a work area for the CPU 101. A secondary storage apparatus 104 is configured by a hard disk or the like, and stores programs run by the CPU 101. The image management application is among these programs. Also, content targeted for searching is stored in the secondary storage apparatus 104. A program in the secondary storage apparatus 104 is read out to the primary storage apparatus 103 and executed by the CPU 101. The display unit 105 is a display apparatus such as a liquid crystal display. An operation unit 106 is configured by a keyboard, a mouse, or the like and accepts an input operation from a user.

Note that although the information processing apparatus 100 can also function as a standalone apparatus, the information processing apparatus 100 may function as a server that connects to a client apparatus via a network. In the case of functioning as a server, the server accepts a designation of a search condition from the client apparatus and searches a content database managed by the server. This content database corresponds to the secondary storage apparatus 104. The content database managed by the server may be a storage apparatus that is managed at a different location and can be accessed via a network. Also, the content targeted for searching does not need to be consolidated in one storage apparatus, and may be recorded so as to be distributed across multiple storage apparatuses.

Search results are transmitted to the client apparatus via the network and displayed to a user on the client apparatus side. In this case, the display on the client apparatus side corresponds to the display unit 105, and the display control unit 102 and the display unit 105 are connected via the network (the Internet or the like). Specifically, the display control unit 102 also functions as a communication control unit for controlling network communication. Also, since a user operation is accepted via the network, functionality corresponding to the operation unit 106 is also performed on the client apparatus side. Although the case where the information processing apparatus 100 is caused to operate as a standalone apparatus is described hereinafter as the embodiment, the information processing apparatus 100 can operate in a similar manner when functioning as a server based on the above-described assumptions.

In the case of performing a search as a server, the present invention also encompasses the case where, for example, a list of reduced images or a list of identification information corresponding to found content is created by the server and transmitted to the client. Also, in the case of performing a search as a server, the present invention also encompasses the case where the actual found content or identification information corresponding to the found content is transmitted to the client as needed, and list data or a list of reduced images is created by the client.

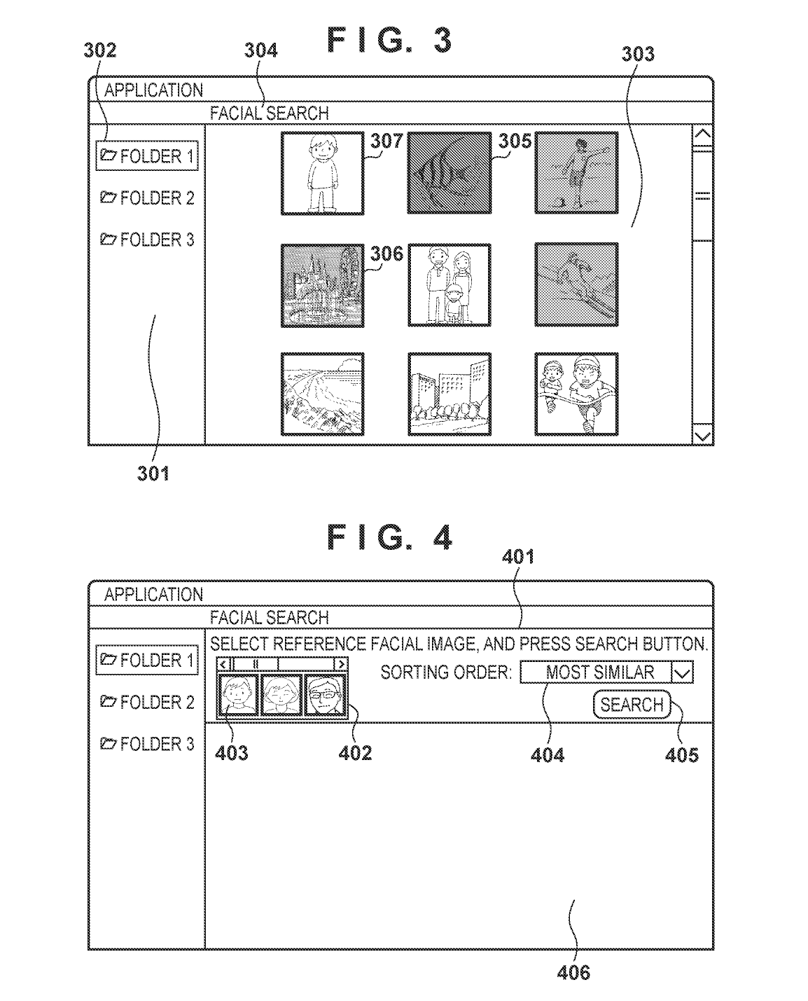

The following describes processing performed by the information processing apparatus 100 using the image management application corresponding to the present embodiment. First, FIG. 3 shows a main screen displayed in the case where the information processing apparatus 100 executes the image management application. As one of its functions, the image management application shown in FIG. 3 can execute a facial search. Although a detailed flow of facial searching will be described later, basically when a facial image serving as a reference is selected, a search is performed for an image determined to be an image that includes the same person as the person in the selected facial image.

For example, if the user selects a facial image of the specific person “Hanako” and executes a facial search, images determined by the image management application to be images including Hanako are displayed as search results. The image management application has a facial region extraction function and a similarity calculation function. In the facial region extraction function, a facial region is extracted by extracting local feature elements of a face from an image and generating placement information. The placement information is used as a feature amount as well, and in the similarity calculation function, a degree of similarity is calculated by comparing the feature amounts of a reference image and a target image. An image is displayed as a similar image among the search results if the calculated degree of similarity is greater than or equal to a predetermined threshold value. Note that the technology regarding facial searching can be widely-known technology, and a detailed description of such technology will not be given since it is not an essential technical feature of the present invention.

Note that regarding a similarity determination in a search other than a facial search, it is possible to use technology for extracting information corresponding to a search key from content targeted for searching, and determine whether a search condition is satisfied.

In FIG. 3, folders managed by the image management application are displayed in a folder selection area 301. A thumbnail display area 303 is for displaying images in the folder that was selected by the user in the folder selection area 301. In the case shown in FIG. 3, a folder 302 has been selected, and images in the folder 302 are being displayed. A menu 304 is for displaying menu items that can be selected by the user, and in the case shown in FIG. 3, “facial search” is being displayed as a selection candidate. A facial search can be executed by selecting “facial search” in this menu.

Note that conceivable examples of user-selectable items other than “facial search” include “subject search”, “color search”, and “keyword search”. Here, “subject search” refers to processing in which the type of subject appearing in an image is identified, and a search is performed for images including a subject similar to the identified subject. Also, “color search” refers to processing in which, for example, the most-used color (representative color) in an image is calculated, or an average color obtained by averaging the color values of the image is calculated, and a search is performed for images that have the same or similar representative color or average color. Furthermore, “keyword search” refers to processing in which character information is accepted as a search condition, and a determination as to whether an image is an image corresponding to the character information is made based on information that can be extracted from the image itself or attribute information attached to the image. The keyword may be any information, such as a color, a subject name, or an imaging location. Regardless of which of these items is selected, processing similar to that described below can be performed.

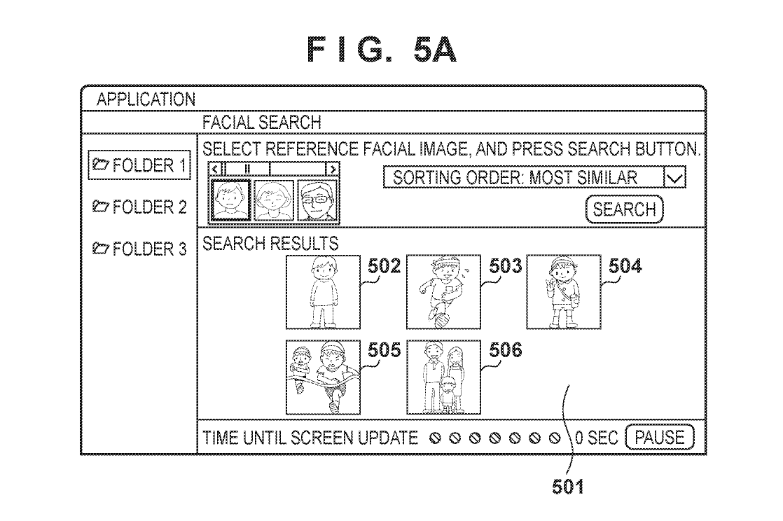

FIG. 4 shows an example of a display of the image management application when “facial search” has been selected from the menu 304. When the menu 304 is selected, a settings panel 401 is displayed. Controls for performing setting of the facial search are provided in the settings panel 401. A selection area 402 is for displaying facial images that can serve as the reference in a selectable manner. In the present embodiment, a list of facial images managed by the image management application is displayed in the selection area 402. The method for registering facial images in the image management application can be a general image registration method, and therefore a description thereof will not be given.

The user selects a facial image that is to be the search key from the facial image list, and thus a search can be performed for an image determined to be an image that includes the same person as the person in the selected facial image. Search result images are displayed in a search result display area 406. Before sorting is performed, images are displayed in the order in which they were found as search results. A list box 404 is a control for selecting the sorting order to be used when displaying the search results. The search result images are displayed sorted according to the sorting order selected using the list box 404. In the case shown in FIG. 4, the sorting order has been set to “most similar”, and therefore when image sorting is performed, the images are displayed in the order of highest degree of similarity at the time when the facial search was performed. In other words, the images are sorted and displayed in the order of highest degree of similarity to a reference facial image 403 that was selected by the user. Conceivable examples of items that can be selected in the list box 404 include the most recent imaging date and ascending or descending filename order. A search button 405 is a button for accepting a search start instruction, and is operated when the search is to be started after the user has selected a reference facial image and a sorting order.

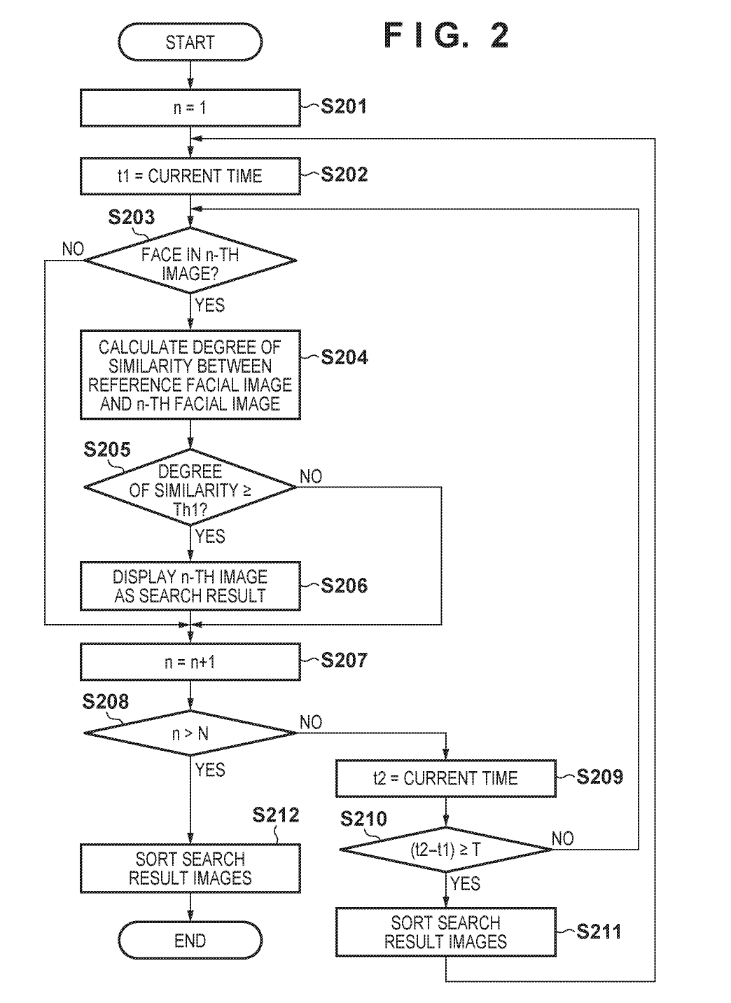

Next, a description of facial search processing corresponding to the present embodiment will be given with reference to FIG. 2. FIG. 2 is a flowchart corresponding to one example of facial search processing. Processing corresponding to this flowchart is realized by the CPU 101 executing the image management application.

If the search button 405 is operated by the user, a facial image search is performed according to the search flow shown in FIG. 2. The following description takes the example of the case where the user selects the reference image 403 and selects “most similar” as the sorting order in the list box 404. If the search button 405 is pressed, in step S201 the CPU 101 sets a variable n held internally by the image management application to 1. Here, n is an index relative to the total number of search target images N, and can have a value from 1 to N. In other words, the total number of search target images is N, and the n-th image among the N images is currently being subjected to search processing. The search target images in the present embodiment are the images in the folder selected by the user in the image management application. In other words, all of the images in the folder 302 selected in FIG. 3 are search targets, and the total number of those images is N. In this description, an image 307 in FIG. 3 is considered to be the image for which n=1.

In step S202, the CPU 101 acquires the current time and assigns it to a variable t1. The current time acquired here is used in a later-described step for determining the time at which image sorting is to be performed. Also, the current time acquired here is assumed to be obtained by acquiring the elapsed time since the image management application was launched, and is assumed to a value such as 1234.567 sec.

Next, in step S203 the CPU 101 determines whether a face appears in the image currently being subjected to search processing. Facial searching cannot be performed if a face does not appear in the image, and therefore the procedure moves to step S207 if a face does not appear. For example, the procedure moves to step S207 in the case of a scenic photograph in which a face does not appear, such as images 305 and 306. The determination of whether a face appears in the image is performed by the above-described facial region extraction function of the image management application. Since a face appears in the image 307, the procedure moves to step S204.

In step S204, the CPU 101 calculates a degree of similarity between the reference facial image and the facial image currently being subjected to search processing. Specifically, a degree of similarity between the reference image 403 selected by the user and the image 307 that is the first image is calculated. The calculation of the degree of similarity between two images is performed by the above-described similarity calculation function of the image management application. In the present embodiment, the degree of similarity can take a value from 0 to 100, and the higher the value is, the closer the facial image is to the reference image.

Next, in step S205 the CPU 101 determines whether the degree of similarity calculated in step S204 is greater than or equal to a predetermined threshold value (Th1). For example, in the case where the threshold value Th1 is set to 70, it is possible to display only images for which the degree of similarity is greater than or equal to 70 as the search results. In other words, in the case where the threshold value is high, the number of search results is low, but images that are more similar to the reference image are displayed as the search results. Conversely, in the case where the threshold value is low, the number of search results is higher, but images that are not very similar to the reference image are also displayed as search results. This threshold value may be a fixed value that is predetermined by the image management application, or the user may be able to set the threshold value to an arbitrary value. If the degree of similarity is greater than or equal to the threshold value Th1, the procedure moves to step S206.

In step S206, the CPU 101 displays the image currently being subjected to search processing as a search result. The search result images are displayed in the search result display area 406 shown in FIG. 4. If the degree of similarity calculated in step S204 is less than the threshold value Th1, the procedure moves from step S205 to step S207, and therefore the image being subjected to search processing is not displayed as a search result. Here, in the case where the degree of similarity between the reference facial image 403 and the image 307 currently being subjected to search processing is 91, and the threshold value used in step S205 is 70, the image 307 is displayed as a search result. Next, in step S207 the CPU 101 adds the value of 1 to the variable n. As previously described, n represents the index of the image being subjected to search processing, and the next image is set as the search target by adding the value of 1 to n. In the present embodiment, the images among the total number of search target images N are sequentially selected and subjected to processing.

Next, in step S208 the CPU 101 determines whether the value of the variable n is greater than the total number of search target images N. In the case where the value of n is greater than N, search processing has been completed for all of the images, and therefore the procedure moves to step S212. In the case where the value of n is less than or equal to N, an image that has not been subjected to search processing remains, and therefore the procedure moves to step S209. In step S209, the CPU 101 acquires the current time and assigns it to a variable t2. Likewise to the above description, the current time acquired here is assumed to be the elapsed time since the image management application was launched, and is assumed to a value such as 1235.678 sec.

Next, in step S210 the CPU 101 calculates the difference between the acquired t2 and t1, and determines whether the difference is greater than or equal to a certain time T corresponding to a sorting interval. For example, in the case where the sorting interval is 7 sec, the calculated difference between the above-described t2 and t1 is 1.111 sec, and therefore the value of T is greater. In this case, the procedure moves to step S203, and search processing is performed on the next image. In this way, search results are displayed sequentially and image sorting is not performed until the predetermined interval T has elapsed. Specifically, in the case where the sorting interval is 7 sec, sorting is not performed for 7 sec.

After the procedure has moved from step S210 to step S203, image searching is performed in the same manner as the flow described above. For example, in the case where search processing is performed on the second image, the procedure moves to step S209, and the current time acquired in step S209 is 1236.789 sec, the difference between t2 and t1 is 2.222 sec. However, this difference is less than the sorting interval of 7 sec, and the procedure again moves to step S203 in this case as well. In the case where the difference between t2 and t1 has become greater than or equal to the sorting interval of 7 sec in step S210 as image searching is repeated in this way, the procedure moves to step S211. In step S211, the CPU 101 performs sorting on the search results.

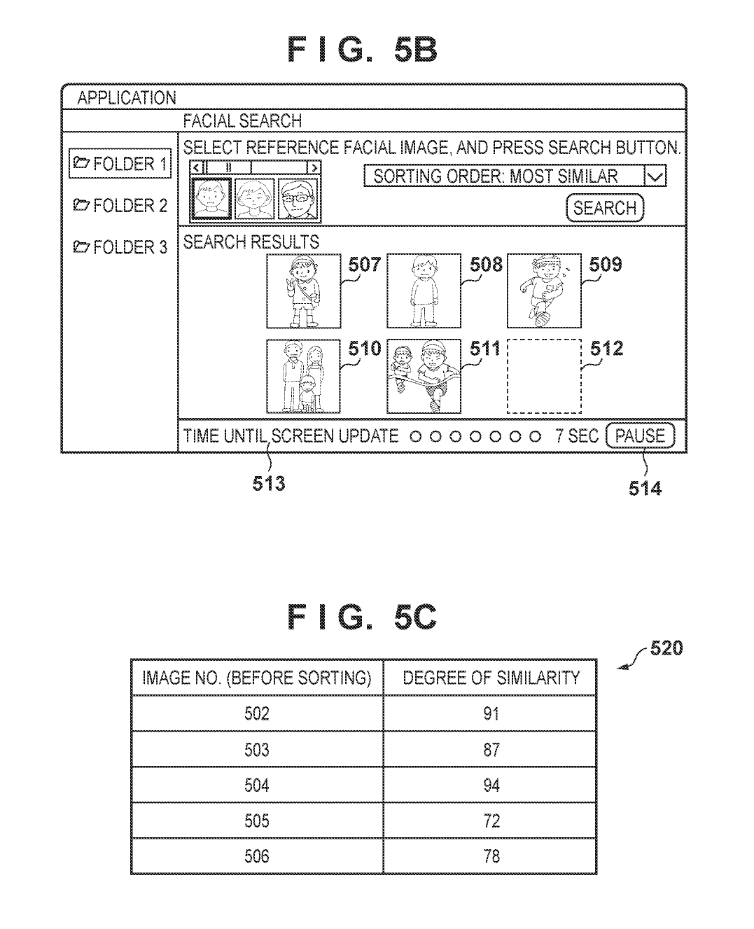

The following describes the sorting of search results with reference to FIGS. 5A to 5C. FIG. 5A shows the image management application immediately before sorting, and FIG. 5B shows the image management application immediately after sorting. In FIG. 5A, a list of five images 502 to 506 is displayed in a search result display area 501. The images 502 to 506 displayed as the search results are reduced images corresponding to the contents that were found, and can be said to be identification information corresponding to the contents that were found. This identification information does not need to be a reduced image, and may be a filename, a symbol or icon image, or a cropped image obtained by trimming part of a content. Also, the identification may be the title of the content, time information, or a comment. Combinations of such identification information may also be used.

Note that the images 502 to 506 are displayed in the order in which they were found, as previously described. FIG. 5C shows a table 520 in which list data of the degrees of similarity between the reference image and the images 502 to 506 has been put into a table format. The table 520 shows that the image with the highest degree of similarity is the image 504. In view of this, the image 504 is displayed at the sorting position having the highest priority when sorting is performed. In other words, the image having the highest degree of similarity is displayed at the position indicated by 507 (upper left of the screen) in FIG. 5B. Next, the image having the second highest degree of similarity in FIG. 5C is the image 502. In view of this, the image 502 is displayed at a position indicated by 508 in FIG. 5B. In this way, after sorting, the images are displayed at the positions of images 507 to 511 in FIG. 5B. The image that is found thereafter is displayed at the position of an image 512.

Note that in FIG. 5B, a remaining time display area 513 is for displaying information indicating the remaining time until the display content of the screen will be updated, and a pause button 514 for giving an instruction to pause the search. In the present embodiment, the remaining time is displayed as a meter indicating the remaining time, and also as the remaining time itself.

As described above, when image sorting is performed, the images displayed as the current search results are displayed according to the sorting order. When image sorting in step S211 ends, the procedure moves to step S202. As previously described, in step S202 the current time is acquired and assigned to the variable t1. In this way, the procedure moves to step S202 after image sorting has been performed, thus resetting the reference time. Thereafter, the above-described steps are repeated. Here, newly found images are displayed by being added to the sorted search results. Also, after the reference time is reset in step S202, if the difference between t2 and t1 in step S210 is greater than or equal to the sorting interval T, sorting is performed again in step S211. After search processing has been completed on all of the images, the procedure moves to step S212. In step S212, the CPU 101 performs sorting on the search result images. This sorting is performed because some of the images are unsorted if the search has ended in the state where images were displayed as search results after sorting was performed in step S211. In view of this, image sorting is performed in step S212 after search processing has been performed on all of the images. The above is a series of processing for performing image searching and sorting.

According to the above processing, the display state is maintained without sorting the search result images until a certain time elapses, and therefore in the case where the user has found a desired content while searching is being performed, that content can be easily selected.

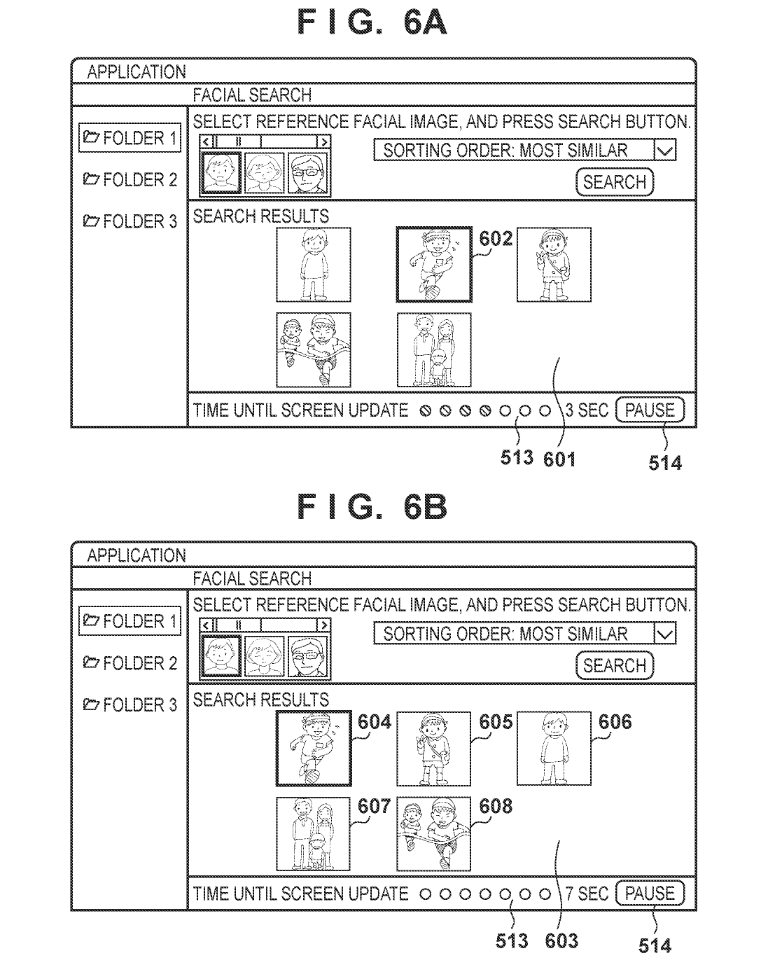

Next, a description will be given of processing in the case where the user has selected an image displayed in the search result display area while searching is being performed. FIG. 6A shows the state in which the user has selected an image 602 among the images displayed in a search result display area 601. By allowing a search result image to be selected even while searching is being performed, in the case where the user has immediately found the desired image, that image can be selected, and the next user operation can be performed. A content can be selected while searching is being performed by selecting a target image through a mouse operation.

In the example shown in FIG. 6A, 3 sec remains until sorting will be performed next as shown in the remaining time display area 513, and it is assumed here that 3 sec elapses without finding a new search result. In this case, sorting is performed on the five images displayed in the search result display area 601, and here the images are sorted according to their degrees of similarity in accordance with the previously described flow shown in FIG. 2. However, the fact that the user selected an image while searching was being performed means that it is possible that the selected image is the image desired by the user. In view of this, the image that the user selected while searching is being performed is displayed at the sorting position having the highest priority. FIG. 6B shows the state of the image management application after sorting has been performed. Here, the images are displayed in a search result display area 603 in the order of highest display priority. The image 602 that was selected in FIG. 6A is displayed at a sorting position 604 having the highest priority. The images that were not selected are displayed sorted according to the sorting order after the image 604. In the case shown in FIG. 6B, it is shown that an image 605 has the highest degree of similarity among the images excluding the image 604, and remaining images 606 to 608 are in the order of highest degree of similarity. Note that if the user selects a different image in the state shown in FIG. 6B, the image newly selected by the user is displayed at the sorting position having the highest priority when sorting is performed next. The image that had been previously selected is then displayed sorted according to its degree of similarity likewise to the other images.

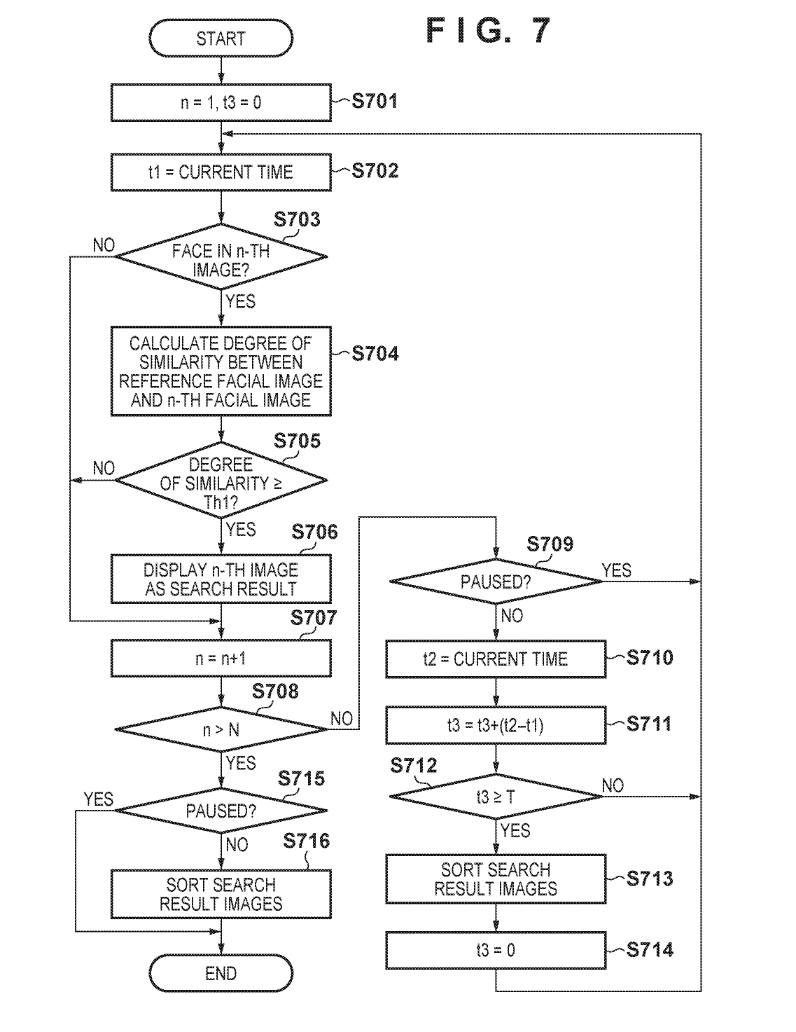

Next, a description will be given of processing for pausing the sorting of images performed at a certain time interval. For example, in the case where a search result image is to be focused on and checked while image searching is being performed, it is conceivable to have the desire to pause sorting while continuing the image searching. In view of this, a button for pausing image sorting is provided as shown by a button 514 in FIGS. 5A and 5B. Pressing this button enables pausing the image sorting performed at a certain time interval. Note that as described above, image searching continues even if sorting is paused. Also, sorting can be resumed after image sorting has been paused. While sorting is paused, the button 514 becomes a resume button, and image sorting can be resumed by pressing the resume button 514 while sorting is paused. A flow of image searching in the case where sorting is paused will now be described with reference to FIG. 7. Note that the search flow shown in FIG. 7 is based on the search flow shown in FIG. 2, and the following description will focus on differences from the flow shown in FIG. 2. Processing corresponding to flowchart shown in FIG. 7 is realized by the CPU 101 executing the image management application.

In step S701, the CPU 101 sets the variable n internally held by the image management application to 1, and sets a variable t3 to 0. As previously described, n is an index relative to the total number of search target images N. Also, t3 is a variable used when determining whether sorting is to be performed, and sorting is performed in the case where the value of t3 is greater than the sorting interval T in a later-described step. The processing of steps S702 to S708 will not be described due to being the same as the processing in the search flow shown in FIG. 2. In step S709, the CPU 101 determines whether image sorting is currently paused. In the case where the pause button 514 shown in FIG. 5B has not been pressed, the procedure moves to step S710.

In step S710, the CPU 101 acquires the current time and assigns it to the variable t2. Next, in step S711 the CPU 101 adds the value of t3 to a value obtained by subtracting t1 from t2, and assigns the result to t3. For example, consider the case where the variable t1 is 1234.567 sec and the variable t2 is 1235.678 sec. Note that the value of 0 was assigned to the variable t3 in step S701. As a result of performing the above-described calculation, the value of t3 is 1.111 sec. In the search flow show in FIG. 2, whether sorting is to be performed is determined by simply calculating the difference between t2 and t1, but in the case shown in FIG. 7, the difference between t2 and t1 is calculated, and the resulting value is added to t3. Then, in step S712 the CPU 101 determines whether the value of t3 is greater than or equal to the sorting interval T. For example, in the case where the sorting interval T is 7 sec and t3 is 1.111 sec, the value of t3 is less than T, and therefore the procedure moves to step S702, and search processing is performed on the next image. After moving to step S702, the processing of steps S702 to S708 is performed likewise to the search processing performed on the first image.

Then, in step S709 it is determined whether image sorting is currently paused. In the case where image sorting is not currently paused, processing is performed likewise to the previously described flow, and therefore the following considers the case where the user presses the pause button after the search processing performed on the first image has ended, and sorting is currently paused. In this case, the procedure immediately moves to step S702 instead of moving to step S710. In other words, the processing of steps S710 to S712 is omitted in the case where sorting is currently paused, and therefore the value of the variable t3 is not increased, and sorting is not performed either.

In this way, it is determined in step S709 whether sorting is currently paused, thus enabling pausing image sorting while the pause button has been pressed. Also, in the case where the user has pressed the resume button while sorting is currently paused, the processing of steps S710 to S712 is performed, and therefore the value of the variable t3 is also increased. In this case, the value obtained by addition before sorting was paused has been assigned to the variable t3. Specifically, in the previously described example, 1.111 sec was assigned to the variable t3. In other words, the value of the variable t3 at the time when sorting was paused is held. Then, and in the case where the value of the variable T3 becomes greater than or equal to the sorting interval T in step S712 as searching is continued, the procedure moves to step S713, in which image sorting is performed. After image sorting has been performed, the value of the variable t3 is reset by assigning the value of 0 to it. Accordingly, in the case where a certain time has elapsed since sorting was last performed before and after the period in which sorting was stopped based on a pause instruction, it is possible to newly perform sorting after the pause instruction is canceled. Note that as a variation of this processing, sorting may be performed immediately after pausing is canceled.

In this way, image searching is performed repeatedly, and the procedure moves to step S715 after search processing has been completed on all of the images. In step S715, the CPU 101 determines whether image sorting is currently paused likewise to step S709. If image sorting is currently paused at the point in time when searched has been performed on all of the images, the search ends without sorting being performed. In the case of the search flow shown in FIG. 2, image sorting is performed even when searching has ended, but in the flow shown in FIG. 7, sorting is not performed even when searching has ended if the pause button has been pressed. Also, if the pause button has not been pressed when searching ends, the procedure moves to step S716 and image sorting is performed likewise to the flow shown in FIG. 2.

According to the above processing, the display state of the search result images can be maintained due to the pause instruction, and therefore in the case where the user has found a desired content while searching is being performed, that content can be easily selected.

Next, a description will be given of processing for displaying the remaining time until sorting will be performed next while content searching is being performed, with reference to FIG. 6A. For example, in the case where the user attempts to select a content among the search results while searching is being performed, if the content is selected immediately before sorting, it is conceivable that sorting will be performed while the user is performing a mouse operation or the like, and that the image that was to be selected will move to a different position. In view of this, displaying the remaining time until sorting will be performed next while content searching is being performed enables providing the user with an indication of the time when content can be selected. The following describes two examples of methods for displaying the remaining time. First is a method for directly displaying the remaining time as a character string as shown by an area 513 shown in FIG. 6A. In the example shown in FIG. 6A, the remaining time of 3 sec is displayed, thus clearly showing that sorting will be performed 3 sec later. Also, the remaining time until sorting will be performed next is displayed in units of 1 sec in this case. Although the remaining time can be displayed in units of 0.001 sec, for example, the remaining time character string needs to be updated in units of 0.001 sec in this case, and it is possible for the display to be bothersome to the user. In view of this, the remaining time is displayed in units of 1 sec in this case.

The second method for displaying the remaining time is a method for displaying icons as shown by the same area 513, and performing control according to the remaining time. Among seven lamps in the example shown in FIG. 6A, the four lamps on the left are lit, and the three lamps on the right are unlit. Here, the fact that 4 sec has already elapsed since the last time sorting was performed is shown by the number of lamps that are lit, and the fact that 3 sec remains until sorting will be performed next is shown by the number of lamps that are unlit.

In other words, the lamps are all unlit when searching is started, and are then lit one at a time in order from the left each time 1 sec elapses. Content sorting is then performed when all of the lamps are lit. After sorting is performed, all of the lamps are extinguished, and the lighting of the lamps is repeated in accordance with the same flow. In this way, the remaining time until sorting will be performed next is indicated according to the number of lamps that are lit or unlit, thus enabling the user to intuitively know the remaining time until sorting will be performed next.

Note that although the lamps are lit each time 1 sec elapses since the sorting interval is 7 sec and the number of lamps is seven in this case, the interval at which the lamps are lit can be determined according to the sorting interval and the number of lamps. For example, in the case where the sorting interval is 20 sec and the number of lamps is 5, it is sufficient to light the lamps each time 4 sec elapses.

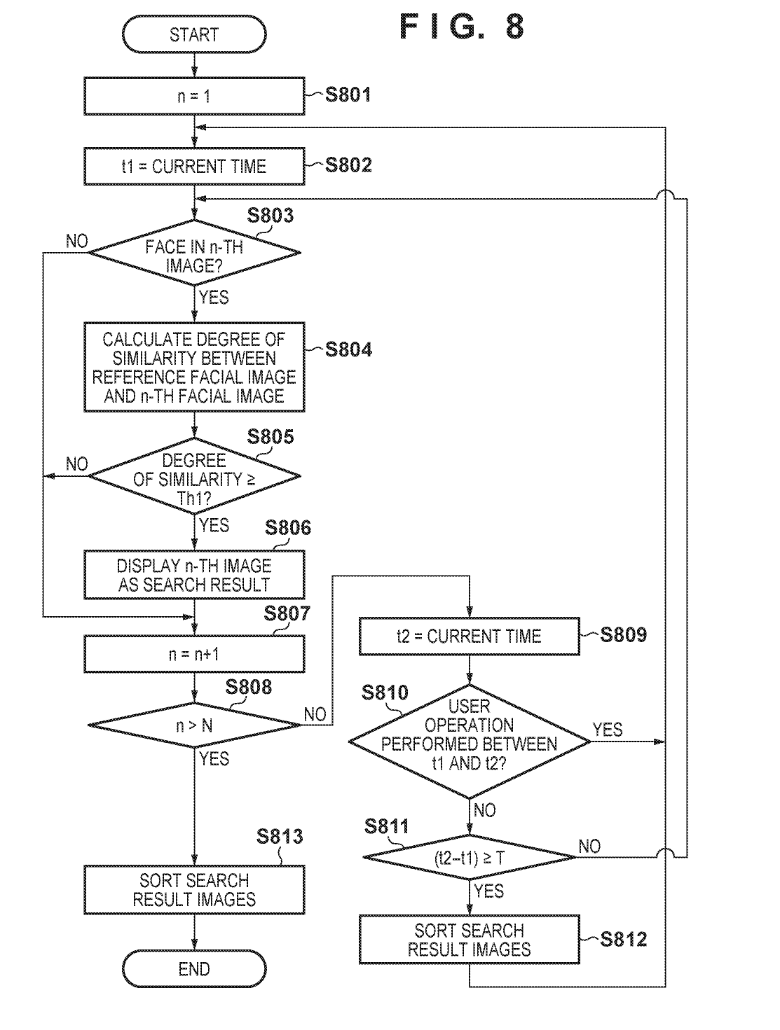

Next, a description will be given of processing in which, when images are sorted while searching is being performed, image sorting is performed each time a predetermined time has elapsed since a user operation ceased to be performed, with reference to FIG. 8. For example, in the case where the user has found an image that is to be focused on and checked while searching is being performed, it is conceivable that the user will attempt to select an image being displayed by performing a mouse or keyboard operation. If the images are sorted while such a user operation is performed, it is conceivable that the image that the user is attempting to select will move to a different position, and the wrong image will be selected. In view of this, a problem such as that described above can be avoided by sorting the images in the case where a predetermined time has elapsed since a user operation ceased to be performed.

The following is a specific description of the search flow shown in FIG. 8. Note that the search flow shown in FIG. 8 is based on the image search flow shown in FIG. 2, and the following description focuses on the processing of step S810 since only the processing of step S810 is different from the flow shown in FIG. 2. The processing of steps S801 to S809 will not be described due to being the same as the processing in the search flow shown in FIG. 2. Next, in step S810 the CPU 101 determines whether a user operation was performed between t1 and t2. Note that the user operation referred to here is an operation performed on the operation unit 106 of the information processing apparatus 100 that is performing searching. Examples of this operation include a mouse operation and a keyboard operation. One example of a method for making this determination is a method in which, in the case where a user operation was performed between t1 and t2, the image management application raises an internal flag, and a determination as to whether a user operation was performed is made by referencing this flag in step S810.

Here, if a user operation was not performed between t1 and t2, the procedure moves to step S811. From step S811 onward, likewise to the previously described search flow shown in FIG. 2, the difference between the variables t2 and t1 is calculated, and it is determined whether the calculated difference is greater than or equal to the sorting interval T. Note that the time interval T may be the same value as the time interval T in step S210 shown in FIG. 2, or may be a different value. Then, in the case where the difference between the variables t2 and t1 is greater than or equal to the sorting interval T, the procedure moves to step S812, in which image sorting is performed, and in the case where the difference between the variables t2 and t1 is less than the sorting interval T, the procedure moves to step S803, and search processing is performed on the next image.

Here, it is assumed that a user operation is not performed before the search processing performed on the first image ends, and then a user operation is performed while search processing is being performed on the second image. In this case, after search processing on the second image ends, the procedure moves from step S810 to S802. After moving to step S802, the current time is assigned to the variable t1, thus resetting the reference time for determining the time when sorting is to be performed. The procedure then moves to step S803, and search processing is performed on the next image. Thereafter, searching is performed by repeating the previously described flow, and image sorting is performed in the case where a user operation was not performed between t1 and t2. Then, image sorting is performed in step S813 after search processing has been performed on all of the images.

According to the above processing, the display state of the search result images can be maintained if the user has operated the operation unit 106, and therefore in the case where the user has found a desired content while searching is being performed, that content can be easily selected. Note that the processing flows corresponding to the flowcharts of FIGS. 2, 7, and 8 may be implemented independently, or an arbitrary combination of these processing flows may be implemented.

Although the present invention is described above based on embodiments, the present invention is not intended to be limited to these specific embodiments, and various embodiments that do not depart from the gist of the invention are also encompassed in the present invention. Portions of the above-described embodiments may be combined appropriately.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-108732, filed May 13, 2011, which is hereby incorporated by reference herein in its entirety.

1-8. (canceled)

9. An information processing apparatus comprising a processor which performs:
executing determination processing that determines one by one in order whether a plurality of content items in memory match a predetermined search condition;
causing a list of information indicating content determined in the determination processing to match the predetermined search condition to display on a display unit;
sorting the information included in the list displayed on the display unit at a predetermined sort timing while the determination processing continues;
adding to the list, if content matching the predetermined search condition is found by the determination processing prior to reaching the sort timing, information indicating that content without sorting the list; and
re-sorting thereafter, and in accordance with lapsing of the sort timing, all information indicating the content determined thus far by the determination processing to match the predetermined search condition.

10. The information processing apparatus according to claim 9, wherein
the processor further performs:
prioritizing, if a selection of content corresponding to information displayed on the display unit is received from a user of the information processing apparatus, a priority level of the content selected in the sorting over other content.

11. The information processing apparatus according to claim 9, wherein
the processor further performs:
stopping, if an instruction to stop the sorting is received from a user of the information processing apparatus, the sorting until a release of the stop instruction is further received; and
adding, if content matching the predetermined search condition is found by the determination processing after receiving the instruction to stop, information indicating the content to the list without sorting the list even if the sort timing lapses.

12. The information processing apparatus according to claim 11, wherein
the processor further performs:
re-sorting of all content determined to match the search condition by the determination processing thus far in accordance with a release of the instruction to stop being performed.

13. The information processing apparatus according to claim 9, wherein
the processor further performs:
stopping, if a predetermined operation is received from a user of the information processing apparatus, the sorting until a time period since the operation ceased to be received reaches a predetermined time; and
adding, if content matching the predetermined search condition is found by the determination processing after receiving the predetermined operation, information indicating that content to the list without sorting the list.

14. The information processing apparatus according to claim 9, wherein
the processor further performs:
causing a remaining time until the sort timing is reached to be displayed on the display unit.

15. A method of controlling an information processing apparatus comprising a processor, the method comprising:
executing determination processing that determines one by one in order whether a plurality of content items in memory match a predetermined search condition;
causing a list of information indicating content determined in the determination processing to match the predetermined search condition to display on a display unit;
sorting the information included in the list displayed on the display unit at a predetermined sort timing while the determination processing continues;
adding to the list, if content matching the predetermined search condition is found by the determination processing prior to reaching the sort timing, information indicating that content without sorting the list; and
re-sorting thereafter, and in accordance with lapsing of the sort timing, all information indicating the content determined thus far by the determination processing to match the predetermined search condition.

16. The method according to claim 15, further comprising:
prioritizing, if a selection of content corresponding to information displayed on the display unit is received from a user of the information processing apparatus, a priority level of the content selected in the sorting over other content.

17. The method according to claim 15, further comprising:
stopping, if an instruction to stop the sorting is received from a user of the information processing apparatus, the sorting until a release of the stop instruction is further received; and
adding, if content matching the predetermined search condition is found by the determination processing after receiving the instruction to stop, information indicating the content to the list without sorting the list even if the sort timing lapses.

18. The method according to claim 17, further comprising:
re-sorting of all content determined to match the search condition by the determination processing thus far in accordance with a release of the instruction to stop being performed.

19. The method according to claim 15, further comprising:
stopping, if a predetermined operation is received from a user of the information processing apparatus, the sorting until a time period since the operation ceased to be received reaches a predetermined time; and
adding, if content matching the predetermined search condition is found by the determination processing after receiving the predetermined operation, information indicating that content to the list without sorting the list.

20. The method according to claim 15, further comprising causing a remaining time until the sort timing is reached to be displayed on the display unit.

21. A non-transitory computer readable storage medium storing a program which causes a processor of an information processing apparatus to perform a method comprising:
executing determination processing that determines one by one in order whether a plurality of content items in memory match a predetermined search condition;
causing a list of information indicating content determined in the determination processing to match the predetermined search condition to display on a display unit;
sorting the information included in the list displayed on the display unit at a predetermined sort timing while the determination processing continues;
adding to the list, if content matching the predetermined search condition is found by the determination processing prior to reaching the sort timing, information indicating that content without sorting the list; and
re-sorting thereafter, and in accordance with lapsing of the sort timing, all information indicating the content determined thus far by the determination processing to match the predetermined search condition.

22. The non-transitory computer readable storage medium according to claim 21, the method further comprising:
prioritizing, if a selection of content corresponding to information displayed on the display unit is received from a user of the information processing apparatus, a priority level of the content selected in the sorting over other content.

23. The non-transitory computer readable storage medium according to claim 21, the method further comprising:
stopping, if an instruction to stop the sorting is received from a user of the information processing apparatus, the sorting until a release of the stop instruction is further received; and
adding, if content matching the predetermined search condition is found by the determination processing after receiving the instruction to stop, information indicating the content to the list without sorting the list even if the sort timing lapses.

24. The non-transitory computer readable storage medium according to claim 23, the method further comprising:
re-sorting of all content determined to match the search condition by the determination processing thus far in accordance with a release of the instruction to stop being performed.

25. The non-transitory computer readable storage medium according to claim 21, the method further comprising:
stopping, if a predetermined operation is received from a user of the information processing apparatus, the sorting until a time period since the operation ceased to be received reaches a predetermined time; and
adding, if content matching the predetermined search condition is found by the determination processing after receiving the predetermined operation, information indicating that content to the list without sorting the list.

26. The non-transitory computer readable storage medium according to claim 21, the method further comprising:
causing a remaining time until the sort timing is reached to be displayed on the display unit.
